(19) United States
(12) Patent Application Publication
(10) Pub. No.: US 2024/0117714 A1
(43) Pub. Date: Apr. 11, 2024

(54) METHOD FOR INCREASING CRUDE OIL PRODUCTION BY CO2 STORAGE IN AQUIFER AND DUMPFLOODING

(71) Applicant: CHINA UNIVERSITY OF PETROLEUM (EAST CHINA), Qingdao (CN)

(72) Inventors: Xianmin ZHANG, Qingdao (CN); Qihong FENG, Qingdao (CN); Chen LIU, Qingdao (CN); Kuankuan WU, Qingdao (CN); Zangyuan WU, Qingdao (CN); Yiming ZHANG, Qingdao (CN); Weina LIU, Qingdao (CN); Jianwei GU, Qingdao (CN)

(21) Appl. No.: 18/393,277

(22) Filed: Dec. 21, 2023

(30) Foreign Application Priority Data
Jul. 21, 2023 (CN) 202310901418.9

(51) Int. Cl. E21B 41/00; C09K 8/594

(52) U.S. Cl. CPC E21B 41/0064; C09K 8/594

(57) ABSTRACT

A method of increasing crude oil production by CO₂ storage in an aquifer and dumpflooding includes the following steps. Wells are drilled in an aquifer in an oil-bearing basin for large-scale CO₂ storage. A low-production and low-efficiency well in an oil-bearing stratum away from the CO₂ storage injection well is selected as an artesian injection well. Formation water in the aquifer with increasing pressure is controlled and guided into the oil-bearing stratum to realize oil displacement by dumpflooding in the oil-bearing stratum.

### CROSS-REFERENCE TO RELATED APPLICATIONS

This application claims the benefit of priority from Chinese Patent Application No. 202310901418.9, filed on Jul. 21, 2023. The content of the aforementioned application, including any intervening amendments thereto, is incorporated herein by reference in its entirety.

### TECHNICAL FIELD

This application relates to oil-gas field development, and more particularly to a method for increasing crude oil production by CO₂ storage in an aquifer and dumpflooding.

### BACKGROUND

The massive emission of greenhouse gases represented by CO₂ has triggered many environmental and ecological problems. The reduction of CO₂ emission has attracted worldwide attention. The researches conducted by European and American countries and Japan have proven that Carbon Capture and Storage (CCS) technology may be one of the effective measures of reducing the CO₂ emission. The sites suitable for geological storage of CO₂ mainly include abandoned oil-gas reservoirs, deep saltwater aquifers and coal seams with no mining value. Sedimentary basins are widely distributed in the land and continental shelf in China, which have a wide distribution area, and a large sedimentary thickness. Moreover, the saline aquifers suitable for geological storage of CO₂ has a large CO₂ storage capacity, and thus are highly potential for CO₂ storage. However, the CCS projects alone cannot bring direct economic benefits and require mass capital investment. At the same time, the pressure accumulation effect in the process of large-scale CO₂ injection will lead to abnormal changes in the pressure of the deep aquifers, which will cause fracture in the overburden layer or fault reactivation, easily resulting in secondary geologic disasters. Therefore, the storage capacity of large-scale industrialized CO₂ injection is largely limited, and it fails to ensure the safety of geological storage. Ex-situ pumping from the geological medium is an effective way to regulate the pressure, but it will further increase the operating cost of CCS. In addition, carbon capture, utilization and storage (CCUS) is also a key large-scale CO₂ emission reduction technology. The CO₂ enhanced oil recovery (EOR) is an effective means to improve the economy of the CCUS technology, but its practical application also faces the following challenges. (1) The CO₂ injection will easily result in gas channeling phenomenon, which will seriously affect the sweep efficiency and reduce the oil displacement effect. (2) When the light components of crude oil are extracted from a CO₂-crude oil mixture, serious asphaltene precipitation will occur, resulting in blockage of the flow channel. (3) After mixed with crude oil, a large amount of CO₂ will be extracted continuously along with the crude oil, and return to the atmosphere, and only a small portion of gas is retained, so that there is still a huge amount of CO₂ needed to be removed by geological storage. Therefore, it is worthwhile to pay attention to how to realize efficient and safe CO₂ injection in oil-gas basins with complex depositional environments and tectonics, control the influence range of the injection operation, and realize synergistic CO₂ storage and increased crude oil production while fully utilizing the underground pore space.

Chinese patent No. 113389533B discloses an integrated method of CO₂ capture, reservoir modification and crude oil extraction. In this patent, an imidazole compound, a metal-organic framework (MOF) material and an alcohol are mixed to form a mixed base fluid, which is used to capture CO₂ from the industrial gas emission. A cross-linking agent and a thickening agent are added to the mixed base fluid that has captured CO₂ to form an alcohol-base fracturing fluid. The alcohol-base fracturing fluid is injected into the reservoir wellhead for fracturing reconstruction of the reservoir, and an acidic gel-breaker plug is injected to release the CO₂ to extract the crude oil.

Chinese patent Publication No. 114278257A discloses a device and method for synchronous offshore oilfield exploitation and supercritical CO₂ storage. By means of a multilateral well, the simultaneous oil-gas exploitation and CO₂ storage in different layers at the same well location is enabled, which not only effectively reduces the CO₂ emission from the operation of an offshore production platform, but also reduces the cost of marine CO₂ storage.

Chinese patent No. 108131122B discloses a method of improving CO₂ storage and crude oil recovery. The pressure safety limit of the target area is determined based on the stability evaluation of caprock and fault in the target area of CO₂ oil displacement and storage. A reasonable pressure maintenance level is selected by reservoir numerical simulation. According to reservoir parameters, suitable production parameters and process methods are selected to realize the longitudinal balanced CO₂ flooding. According to the non-homogeneity of the reservoirs in the target area and the abundance distribution of the remaining reserve, variable well pattern and spacing and differential reservoir modification are used to realize the planar balanced CO₂ flooding. The injection-production flow line is adjusted by optimizing the injection method, injection rate, injection-production regulation methods and foam plugging methods.

Chinese patent Publication No. 115637966A discloses a method for geothermal-driven catalytic reduction CO₂ storage and oil recovery. The method combines the liquid nitrogen fracturing with injectant injection, and fully utilizes the thermal energy of the deep geothermal reservoir. The method also introduces a nano-Cu-based catalyst to realize the hydrothermal cracking reaction of crude oil as well as the CO₂ thermal reduction reaction, thereby improving the crude oil recovery rate, the CO₂ storage capacity, storage stability, and storage efficiency.

In the above-mentioned patent literatures, the crude oil recovery rate, CO₂ storage capacity and storage efficiency are improved often by CO₂ injection control in oil reservoirs and synergistic oil recovery and CO₂ storage. However, it is still difficult to realize large-scale CO₂ storage in oil-gas reservoirs. Therefore, how to find a more suitable technology for synergistic CO₂ storage and enhanced crude oil production in oil-gas basins to further solve the problems of the existing technical solutions have received extensive attention.

### SUMMARY

In view of the deficiencies in the prior art, this application provides a method for increasing crude oil production by CO₂ storage in an aquifer and dumpflooding. A well is drilled in an aquifer of an oil-gas bearing basin for large-scale CO₂ storage, and at the same time, a low-production and low-efficiency well away from the CO₂ injection well at the oil-bearing stratum is selected as the artesian injection well. The groundwater with a continuously-rising pressure is controlled and guided to flow from the aquifer into the oil-bearing stratum, thereby enabling the dump flooding for oil displacement in the oil-bearing stratum. This application can not only achieve the large-scale safe CO₂ storage in the deep aquifer, but also enhance the crude oil recovery from the oil-bearing stratum.

Technical solutions of this application are described as follows.

This application provides a method of increasing crude oil production by CO₂ storage in an aquifer and dump flooding, comprising:

(1) selecting an aquifer within a regional unit of an oil-bearing basin; drilling at least one CO₂ injection well in a structural high part of the aquifer, wherein a perforation position of each of the at least one CO₂ injection well is located at a middle-lower part of the aquifer; and within the regional unit of the oil-bearing basin, selecting a deep aquifer with a wide distribution, a burial depth of greater than 800 m, a stable regional cap-rock or an aquiclude, few faults or strong fault sealing, a formation water salinity of greater than 3 g/L, and good compatibility with an oil-bearing stratum;

(2) drilling at least two production wells for depletion development in the regional unit of the oil-bearing basin, wherein at least one of the at least two production wells is drilled to encounter both an oil-bearing stratum and the aquifer; and a perforation position of each of the at least two production wells is located at a middle-upper part of the oil-bearing stratum;

(3) from the at least two production wells, selecting one with a distance of 3 km or more from the at least one CO₂ injection well, and a daily oil production of less than 2 t/d or insufficient fluid supply for normal production as an artesian injection well; and perforating the artesian injection well at the middle-lower part of the aquifer, so as to communicate the aquifer with the oil-bearing stratum through a wellbore of the artesian injection well;

(4) deploying a flow-pressure detecting-controlling device in the artesian injection well, wherein the flow-pressure detecting-controlling device is located near a junction of the oil-bearing stratum and an interbedded stratum in the wellbore, and is configured to monitor and control a dump flooding rate and a flooding pressure, which can be realized by adopting a variety of structures of the prior art; and deploying sequentially a first packer and a second packer in the artesian injection well, wherein the first packer is located near a top boundary of the aquifer for isolating and sealing a well section above the aquifer; and the second sealer is located near a bottom boundary of the oil-bearing stratum for isolating and sealing a well section below the oil-bearing stratum; and

(5) continuously injecting CO₂ into a geological body of the aquifer for storage through the at least one CO₂ injection well; based on an reservoir pressure accumulation effect within the aquifer during the storage of CO₂, under the action of a pressure difference between the aquifer and the oil-bearing stratum, allowing formation water in the aquifer to flow into the wellbore of the artesian injection well and the flow-pressure detecting-controlling device; adjusting a flow rate and the flooding pressure of the flow-pressure detecting-controlling device, to make the formation water within the aquifer to flow into the oil-bearing stratum at a preset flow rate to displace crude oil to an adjacent production well for extraction.

Compared to the prior art, this application has the following beneficial effects.

CO₂ is injected into the deep aquifer for large-scale storage, and is used to drive the formation water in the deep aquifer to flow into the oil-bearing stratum for oil displacement. On one hand, it can effectively alleviate the problems of reservoir pressure accumulation and salt precipitation in the large-scale CO₂ injection into the deep aquifer, improve the injectability and safety of CO₂, and significantly increase the dissolved and captured amount of CO₂, thereby effectively improving the storage efficiency of CO₂. On the other hand, the dump flooding is enabled by controlling the pressure difference between the aquifer and the oil-bearing stratum, which can effectively replenish the energy deficit of the oil-bearing stratum, improve the development effect of the oil-bearing stratum regional unit, and realize the maximized utilization of oil-gas resources and underground reservoir space. Therefore, this application can not only alleviate the shortage of strategic resources, but also produce obvious economic and social benefits.

### BRIEF DESCRIPTION OF THE DRAWINGS

FIG. 1 schematically shows a method for increasing crude oil production by CO₂ storage in aquifer and dumpflooding according to one embodiment of the present disclosure.

In the FIGURE: 1—aquifer; 2—oil-bearing stratum; 3—regional cap-rock; 4—interbedded stratum; 5—CO₂ injection well; 6—first production well; 7—second production well; 8—third production well; 9—flow-pressure detecting and controlling device; 10—first packer; and 11—second packer.

### DETAILED DESCRIPTION OF EMBODIMENTS

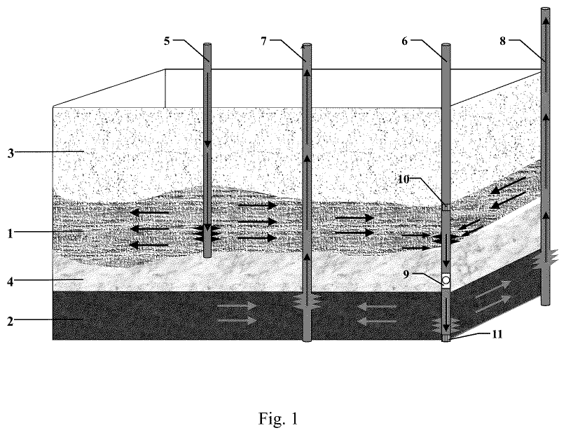

FIG. 1 schematically shows a method for increasing crude oil production by CO₂ storage in an aquifer and dumpflooding, which includes the following steps.

(1) Within the regional unit of the oil-bearing basin, the aquifer 1 with a wide distribution, a burial depth of greater than 800 m, a stable regional cap-rock, few faults or strong fault sealing, a formation water salinity of greater than 3 g/L, and good compatibility with an oil-bearing stratum is selected. One CO₂ injection well 5 is drilled in a structural high part of the aquifer 1.

In this embodiment, there is the stable regional cap-rock 3 above the aquifer 1, and there is an interbedded stratum 4 between the aquifer 1 and the oil-bearing stratum 2. The first injection position of the CO₂ injection well is located at a middle-lower part of the aquifer 1.

(2) Three production wells are drilled in the regional unit of the oil-bearing stratum 2 in the oil-bearing basin, namely a first production well 6, a second production well 7, and a third production well 8, for depletion development.

In this embodiment, the first production well 6, the second production well 7, and the third production well 8 are drilled to encounter both the aquifer 1 and the oil-bearing stratum 2. The perforation positions of the first production well 6, the second production well 7, and the third production well 8 are located at the middle-upper part of the oil-bearing stratum 2. The well spacing between the first production well 6, the second production well 7, and the third production well 8 ranges between 200 m and 500 m.

(3) From the production wells, one production well with the distance of 3 km or more from the CO₂ injection well 5, and the daily oil production of less than 2 t/d or insufficient fluid supply for normal production is selected as an artesian injection well. The artesian injection well is perforated at the middle-lower part of the aquifer 1, so as to communicate the aquifer 1 with the oil-bearing stratum 2 through the wellbore of the artesian injection well.

In this embodiment, the first production well 6, which has insufficient fluid supply for normal production, is preferred as the artesian injection well. The first production well 6 is perforated at the middle-lower part of the aquifer 1, while perforating the oil-bearing stratum 2 and the aquifer 1 above the oil-bearing stratum 2.

(4) The flow-pressure detecting-controlling device 9 is deployed in the first production well 6. In this embodiment, the flow-pressure detecting-controlling device 9 is located at the junction of the oil-bearing stratum 2 and the interbedded strata 4 in the wellbore, so as to monitor and control the dumpflooding rate and the flooding pressure, which can be realized by adopting a variety of structures of the existing technology. The first packer 10 and the second packer 11 are deployed in the first production well 6.

In this embodiment, the flow-pressure detecting-control device 9 is provided with a pressure sensor and a flow meter together. The pressure sensor can monitor the pressure of the oil-bearing stratum in the wellbore of the first production well 6. The flow meter can monitor and control the dump flooding rate, and adjust the flooding pressure of the oil-bearing stratum in the wellbore of the first production well 6.

In this embodiment, the first packer 10 is located at a top boundary of the aquifer 1 for isolating and sealing a well section above the aquifer 1. The second packer 11 is located at a bottom boundary of the oil-bearing stratum 2 for isolating and sealing a well section below the oil-bearing stratum 2.

(5) CO₂ fluid is continuously injected into the geological body of the aquifer 1 for large-scale storage through the CO₂ injection well 5. At the same time, based on the reservoir pressure accumulation effect within the aquifer 1 during the large-scale storage of CO₂, and under the action of the progressively increasing pressure difference between the aquifer 1 and the oil-bearing stratum 2, the formation water within the aquifer 1 flows into the wellbore of the first production well 6 and the flow-pressure detecting-controlling device 9. The flow rate and flooding pressure of the flow-pressure detecting-controlling device 9 are adjusted to control the formation water within the aquifer 1 to inject into the oil-bearing stratum 2 at a reasonable flow rate, thereby displacing crude oil to the neighboring second production well 7 and third production well 8. Then the crude oil is extracted from the second production well 7 and third production well 8.

By injecting CO₂ into the deep aquifer for large-scale storage and controlling and guiding the formation water in the deep aquifer to flow into the oil-bearing stratum, the disclosure realizes synergistic oil displacement by CO₂ geological storage in the deep aquifer and by dump flooding in the oil-bearing stratum. On one hand, the disclosure improves the injectability and safety of the large-scale storage of CO₂ and effectively improves the storage efficiency of CO₂. On the other hand, the disclosure can effectively replenish the energy of the oil-bearing stratum, improve the development effect of crude oil in the oil-bearing stratum, maximize the utilization of oil-gas resources and underground reservoir space, and obtain the double benefits of economy and environmental protection, which has great potential for application in the geographical areas where the oil-gas production industry develops faster and water is scarce, such as Xinjiang and Inner Mongolia.

What is claimed is:

1. A method of increasing crude oil production by CO₂ storage in an aquifer and dumpflooding, comprising:
(1) selecting an aquifer within a regional unit of an oil-bearing basin; drilling at least one CO₂ injection well in a structural high part of the aquifer, wherein a perforation position of each of the at least one CO₂ injection well is located at a middle-lower part of the aquifer; and within the regional unit of the oil-bearing basin, selecting a deep aquifer with a burial depth of greater than 800 m and a formation water salinity exceeding 3 g/L;
(2) drilling at least two production wells for depletion development in the regional unit of the oil-bearing basin, wherein at least one of the at least two production wells is drilled to encounter both an oil-bearing stratum and the aquifer; and a perforation position of each of the at least two production wells is located at a middle-upper part of the oil-bearing stratum;
(3) from the at least two production wells, selecting one with a distance of 3 km or more from the at least one CO₂ injection well, and a daily oil production of less than 2 t/d or insufficient fluid supply for normal production as an artesian injection well; and perforating the artesian injection well at the middle-lower part of the aquifer, so as to communicate the aquifer with the oil-bearing stratum through a wellbore of the artesian injection well;
(4) deploying a flow-pressure detecting-controlling device in the artesian injection well, wherein the flow-pressure detecting-controlling device is located near a junction of the oil-bearing stratum and an interbedded stratum in the wellbore, and is configured to monitor and control a dump flooding rate and a flooding pressure; and deploying sequentially a first packer and a second packer in the artesian injection well, wherein the first packer is located near a top boundary of the aquifer for isolating and sealing a well section above the aquifer; and the second sealer is located near a bottom boundary of the oil-bearing stratum for isolating and sealing a well section below the oil-bearing stratum; and
(5) continuously injecting CO₂ into a geological body of the aquifer for storage through the at least one CO₂ injection well; based on an reservoir pressure accumulation effect within the aquifer during the storage of CO₂, under the action of a pressure difference between the aquifer and the oil-bearing stratum, allowing formation water in the aquifer to flow into the wellbore of the artesian injection well and the flow-pressure detecting-controlling device; adjusting a flow rate and the flooding pressure of the flow-pressure detecting-controlling device, to make the formation water within the aquifer to flow into the oil-bearing stratum at a preset flow rate to displace crude oil to an adjacent production well for extraction.
